(19) United States
(12) Patent Application Publication
(10) Pub. No.: US 2015/0153775 A1
(43) Pub. Date: Jun. 4, 2015

(54) SCREEN PROTECTION DEVICE FOR PROTECTING DISPLAY SCREEN OF ELECTRONIC APPARATUS

(71) Applicant: Uniproo Inc., Bade City (TW)

(72) Inventors: Kuo-Liang CHENG, New Taipei City (TW); Chun-Hung SU, New Taipei City (TW)

(73) Assignee: Uniproo Inc., Bade City (TW)

(21) Appl. No.: 14/093,885

(22) Filed: Dec. 2, 2013

(51) Int. Cl. G06F 1/16

(52) U.S. Cl. CPC G06F 1/1637

(57) ABSTRACT

A screen protection device for protecting a display screen of an electronic apparatus includes: a tempered glass sheet, a mask layer, an adhesive layer, and a two-part Epoxy glue layer. The mask layer is positioned on the tempered glass sheet and defines a transparent region for the screen protection device. The adhesive layer is positioned on at least a portion of the mask layer and surrounds the transparent region, and is utilized for detachably attaching to a target region on a surface of the hand-held electronic apparatus. The two-part Epoxy glue layer is positioned on the tempered glass sheet and covers the transparent region. When the adhesive layer is attached to the target region, the two-part Epoxy glue layer is positioned between the tempered glass sheet and the display screen, directly contacts with the display screen, and detachably attaches to the display screen.

### BACKGROUND

The present disclosure generally relates to a screen protection device and, more particularly, to a screen protection device for protecting a display screen of an electronic apparatus that can avoid the phenomenon of Newton's rings.

To prevent a touch screen of an electronic apparatus from being scratched or smudged, many people choose to paste a screen protection sheet on a surface of the touch screen to protect the touch screen.

U.S. Pat. No. 8,044,942 discloses a kind of screen protector to avoid air bubbles between the screen protector and the surface of the touch screen. The screen protector disclosed in the U.S. Pat. No. 8,044,942 includes a plastic film having an outer perimeter and a transparent window; and a spacer provided along the outer perimeter of the plastic film surrounding the transparent window and having a thickness sufficient to space the plastic film near but not in contact with the touch screen portion; and an exposed adhesive for mounting the screen protector upon an outer perimeter of the touch screen to form an enclosed air space between the transparent window, the spacer, and the touch screen.

However, after multiple times of pressing the afore-mentioned screen protector, the transparent window of the screen protector deforms and becomes sunken because the amount of air in the enclosed air space reduces. Once the screen protector becomes sunken, when the light passes through the transparent window and the touch screen, the reflected light of the transparent window and the reflected light of the touch screen form interference fringes. In this situation, multiple circular fringes arranged concentrically on the touch screen will be perceived by the user. This phenomenon is also known as Newton's rings. The presence of the Newton's rings would interfere with the images displayed by the touch screen and degrade the visual effect of the images and may even cause discomfort to human eyes.

### SUMMARY

An example embodiment of a screen protection device for protecting a display screen of an electronic apparatus is disclosed. The screen protection device comprises: a tempered glass sheet having a first surface and a second surface; a mask layer positioned on the first surface of the tempered glass sheet and defining a transparent area for the screen protection device, wherein the transparent area has a shape corresponding to the display screen of the electronic device; an adhesive layer positioned on at least a portion of the mask layer, surrounding the transparent area, and utilized for detachably attaching to a target region of a surface of the electronic apparatus; and a two-part Epoxy glue layer positioned on the first surface of the tempered glass sheet and covering the transparent area, wherein when the adhesive layer is attached onto the target region of the electronic apparatus, the two-part Epoxy glue layer is positioned between the tempered glass sheet and the display screen, directly contacts with the display screen, and detachably attaches onto the display screen; wherein a thickness of the two-part Epoxy glue layer is at least 60% of a total thickness of the mask layer and the adhesive layer.

Another example embodiment of a screen protection device for protecting a display screen of an electronic apparatus is disclosed. The screen protection device comprises: a tempered glass sheet having a first surface and a second surface, wherein the tempered glass sheet has a thickness between 0.35 to 0.7 millimeters; a mask layer positioned on the first surface of the tempered glass sheet and defining a transparent area for the screen protection device, wherein the transparent area has a shape corresponding to the display screen of the electronic device; an adhesive layer positioned on at least a portion of the mask layer, surrounding the transparent area, and utilized for detachably attaching to a target region of a surface of the electronic apparatus, wherein the adhesive layer has a thickness less than a thickness of the mask layer, and a total surface area of the adhesive layer is less than a total surface area of the mask layer; a harden layer positioned on the second surface of the tempered glass sheet to protect the second surface of the tempered glass sheet; a two-part Epoxy glue layer positioned on the first surface of the tempered glass sheet and covering the transparent area, wherein the two-part Epoxy glue layer has a diagonal greater than 5 inches, and a thickness of the two-part Epoxy glue layer is at least 80% of a thickness of the mask layer; and at least one opening positioned outside the transparent area of the screen protection device and penetrating the tempered glass sheet, the mask layer, and the adhesive layer; wherein when the adhesive layer is attached onto the target region of the electronic apparatus, the two-part Epoxy glue layer is positioned between the tempered glass sheet and the display screen, directly contacts with the display screen, and detachably attaches onto the display screen.

Both the foregoing general description and the following detailed description are examples and explanatory only, and are not restrictive of the invention as claimed.

### BRIEF DESCRIPTION OF THE DRAWINGS

FIG. 1 is a schematic front view diagram of a screen protection device in accordance with an example embodiment.

FIG. 2 is a schematic cross-sectional diagram of the screen protection device along the direction A-A′ of FIG. 1.

FIG. 3 is a schematic cross-sectional diagram of the screen protection device along the direction B-B′ of FIG. 1.

FIG. 4 is a schematic cross-sectional diagram of the screen protection device along the direction C-C′ of FIG. 1.

FIG. 5 is a schematic back view diagram of a screen protection device in accordance with another example embodiment.

FIG. 6 is a schematic cross-sectional diagram of the screen protection device along the direction D-D′ of FIG. 5.

### DETAILED DESCRIPTION

Reference is made in detail to embodiments of the invention, which are illustrated in the accompanying drawings. The same reference numbers may be used throughout the drawings to refer to the same or like parts, components, or operations.

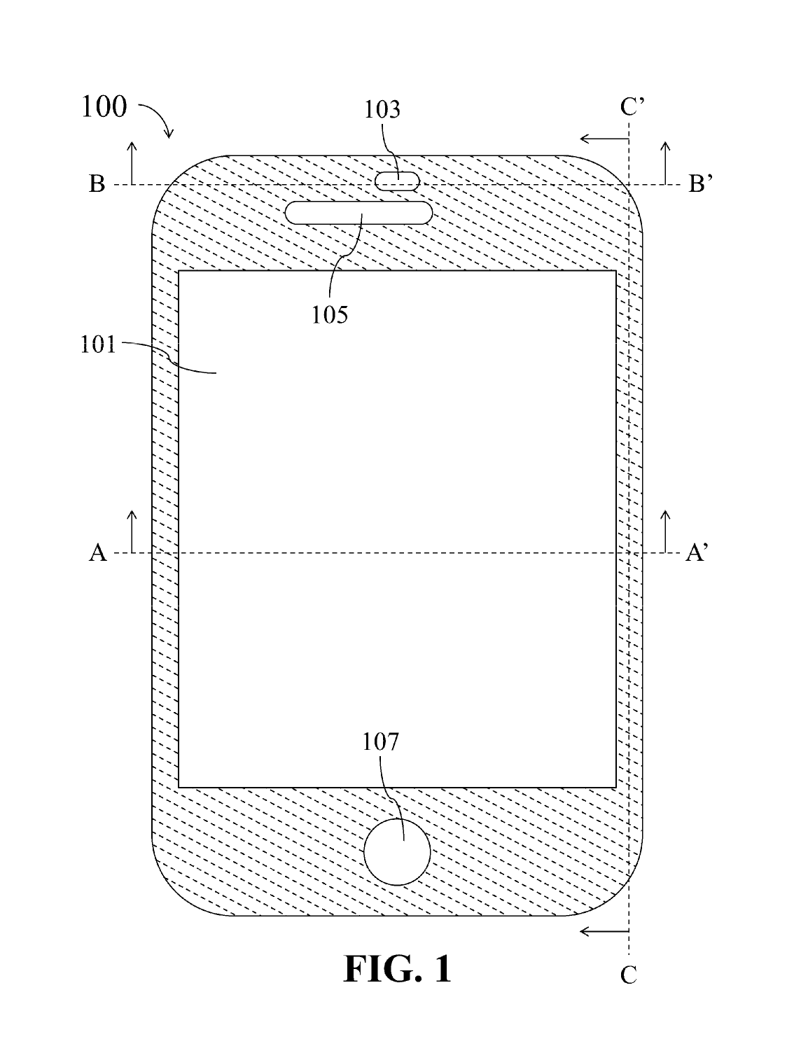

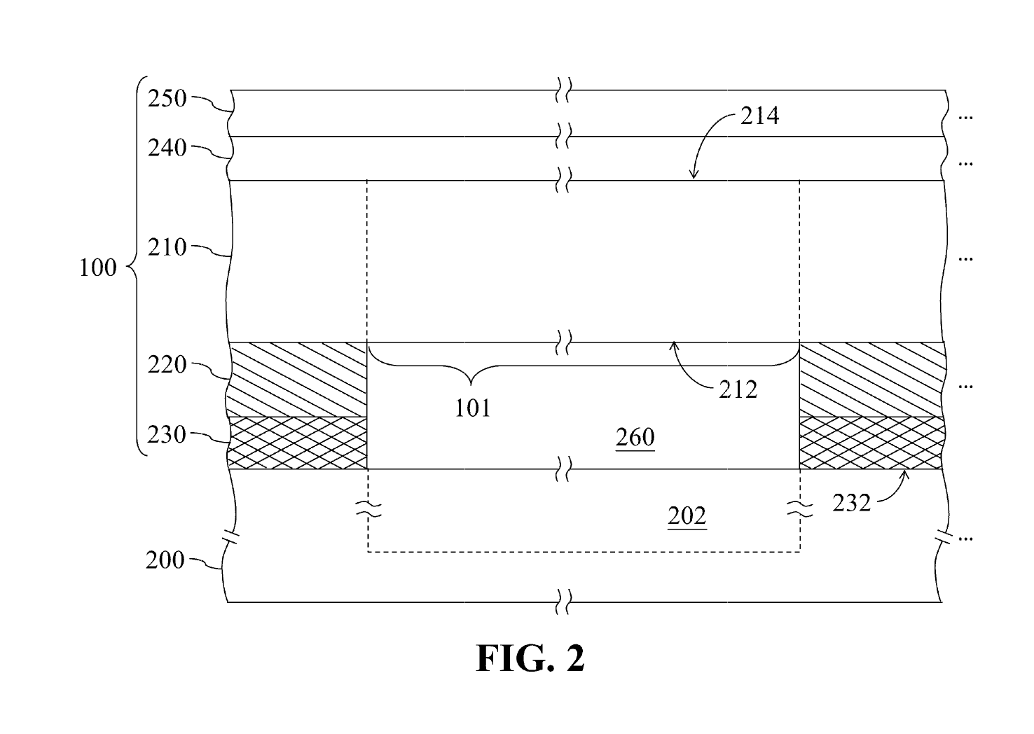

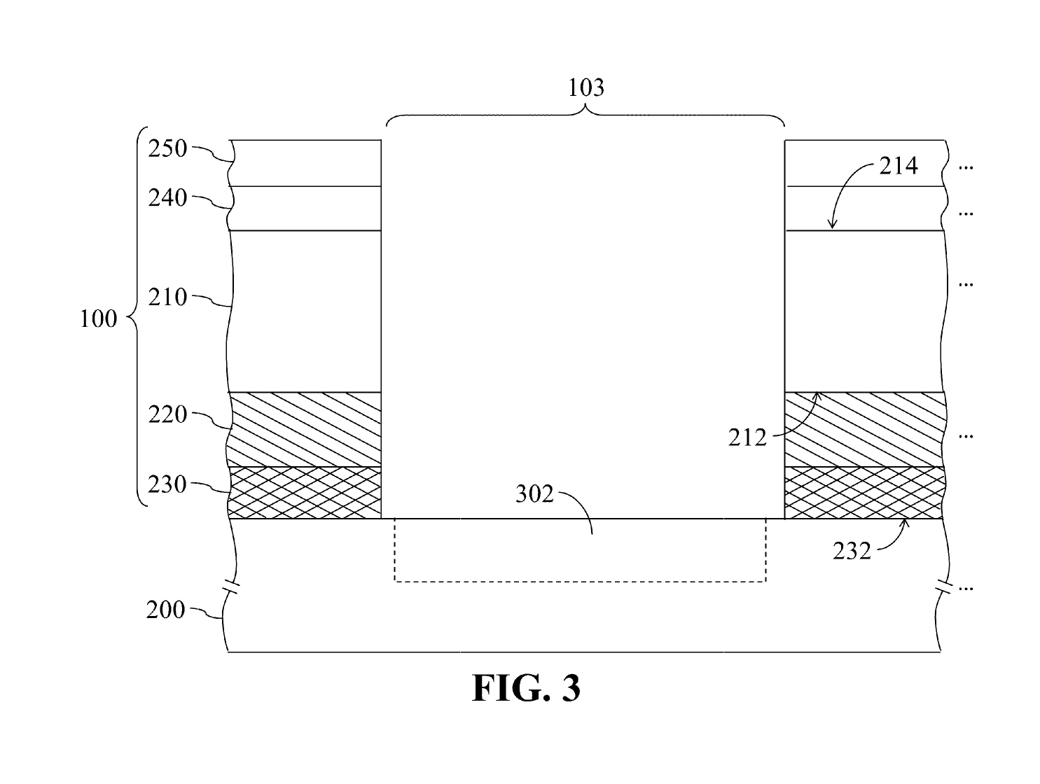

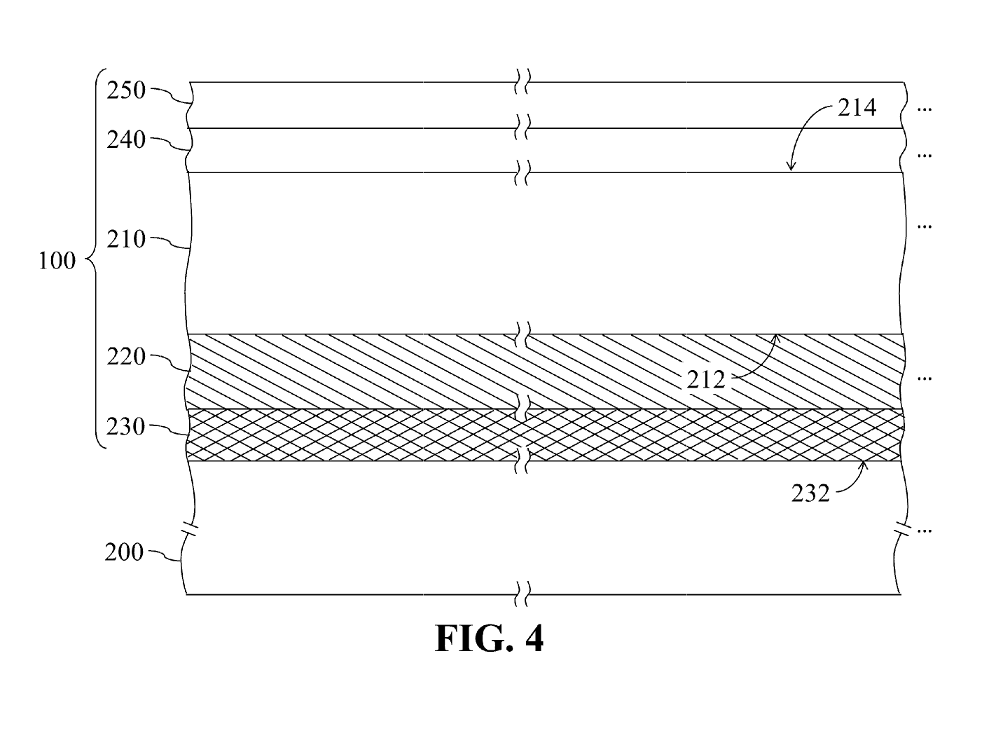

Please refer to FIG. 1 to FIG. 4. FIG. 1 is a schematic front view diagram of a screen protection device 100 in accordance with an example embodiment. FIG. 2 is a schematic cross-sectional diagram of the screen protection device 100 along the direction A-A′ of FIG. 1. FIG. 3 is a schematic cross-sectional diagram of the screen protection device 100 along the direction B-B′ of FIG. 1. FIG. 4 is a schematic cross-sectional diagram of the screen protection device 100 along the direction C-C′ of FIG. 1. The screen protection device 100 may be utilized for attaching onto a surface of an electronic apparatus 200 to avoid the surface of a display screen 202 of the electronic apparatus 200 from being damaged. The electronic apparatus 200 may be any kind of electronic devices having a display screen, such as any hand-held mobile communication device (e.g., cell phone, tablet computer, or notebook computer) or may be a television, a computer screen, or any other display device.

The screen protection device 100 may be provided with one or more openings corresponding to the components on the electronic apparatus 200. In the embodiment of FIG. 1, for example, openings 103 and 105 are positioned near one end of the screen protection device 100, and an opening 107 is positioned near the other end of the screen protection device 100. The openings 103, 105, and 107 are respectively positioned corresponding to a front-end camera, an earphone, or a control button of the electronic apparatus 200 to avoid the previous elements from being blocked by the screen protection device 100. When the user wants to attach the screen protection device 100 onto the electronic apparatus 200, the openings 103, 105, and 107 may be utilized as an alignment basis so that the user can accurately attach the screen protection device 100 onto the electronic apparatus 200.

As shown in FIG. 2 through FIG. 4, the screen protection device 100 of this embodiment comprises a tempered glass sheet 210, a mask layer 220, an adhesive layer 230, a harden layer 240, an antibacterial layer 250, and a two-part Epoxy glue layer 260.

The tempered glass sheet 210 is utilized as a main body of the screen protection device 100, and has a thickness between 0.35 to 0.7 millimeters, such as 0.5 millimeters. The tempered glass sheet 210 comprises a first surface 212 facing to the electronic apparatus 200 and a second surface 214 back to the electronic apparatus 200.

The mask layer 220 is positioned on the first surface 212 of the tempered glass sheet 210 and defines a transparent area 101 for the screen protection device 100. The transparent area 101 has a shape corresponding to a shape of the display screen 202 of the electronic apparatus 200 and is surrounded by the mask layer 220. The mask layer 220 may be realized by an opaque or a translucent material to mask the adhesive layer 230. In practice, for example, the mask layer 220 may be formed by printing dyes of a specific color, such as black or white, on the first surface 212 of the tempered glass sheet 210.

The adhesive layer 230 is positioned on at least a portion of the mask layer 220 and surrounds the transparent area 101. The adhesive layer 230 comprises a sticking surface 232 for detachably attaching onto a target region of a surface of the electronic apparatus 200. The afore-mentioned target region may be located with the display screen 202, or may be located outside the display screen 202. The adhesive layer 230 may have a thickness less than a thickness of the mask layer 220. In practice, the adhesive layer 230 may be attached onto the target region of the electronic apparatus 200 through an electrostatic adhesion manner or other adhesion approaches. With the adhesive layer 230, the screen protection device 100 may be rapidly attached onto the surface of the electronic apparatus 200 and removed from the surface of the electronic apparatus 200 without leaving any residue or trace of glue on the surface of the electronic apparatus 200.

The harden layer 240 is positioned on the second surface 214 of the tempered glass sheet 210 to protect the second surface 214. In practice, a hardening agent may be coated on the second surface 214 of the tempered glass sheet 210 to form the harden layer 240 to thereby increase the hardness of the screen protection device 100.

The antibacterial layer 250 is positioned on the harden layer 240 to reduce or avoid bacteria. In practice, an anti-fog (AF) potion or an anti-smudge (AS) potion may be coated on the harden layer 240, and the antibacterial layer 250 is formed when the AF potion or the AS potion dries to provide anti-smudge and nano-antibacterial functionalities to reduce or avoid bacteria.

The two-part Epoxy glue layer 260 is positioned on the first surface 212 of the tempered glass sheet 210 and covers the transparent area 101. When manufacturing the screen protection device 100, a two-part Epoxy glue (also known as AB glue) may be smoothly coated on the area surrounded by the mask layer 220 (i.e., the above-mentioned transparent area 101) on the first surface 212 of the tempered glass sheet 210, and the two-part Epoxy glue layer 260 with supporting functionality is formed when the two-part Epoxy glue is cured. When the adhesive layer 230 is attached to the target region of the electronic apparatus 200, the two-part Epoxy glue layer 260 is positioned between the tempered glass sheet 210 and the display screen 202, directly contacts with the display screen 202, and detachably attaches onto the display screen 202. In this situation, the two-part Epoxy glue layer 260 acts as a pad layer between the tempered glass sheet 210 and the display screen 202.

As shown in FIG. 2, when the adhesive layer 230 of the screen protection device 100 is attached to the target region of the electronic apparatus 200, the two-part Epoxy glue layer 260 positioned between the tempered glass sheet 210 and the display screen 202 acts as a supporting element for supporting the tempered glass sheet 210 to avoid the tempered glass sheet 210 from deforming toward the display screen 202 due to gravity, elastic fatigue, or other issues. Therefore, with the supporting of the two-part Epoxy glue layer 260, the electronic apparatus 200 can be effectively avoided from the phenomenon of Newton's rings.

Each of the afore-mentioned openings 103, 105, and 107 is positioned outside the transparent area 101 of the screen protection device 100, and thus does not passes through the two-part Epoxy glue layer 260. However, each of the afore-mentioned openings 103, 105, and 107 penetrates the tempered glass sheet 210, the mask layer 220, and the adhesive layer 230 so as to avoid the front-end camera, the earphone, and the control button of the electronic apparatus 200 to be blocked by the tempered glass sheet 210, the mask layer 220, or the adhesive layer 230. For example, as shown in FIG. 3, when the screen protection device 100 is attached onto the surface of the electronic apparatus 200, the opening 103 of the screen protection device 100 is aligned with a front-end camera 302 of the electronic apparatus 200 so that the front-end camera 302 is allowed to successively capture images through the opening 103.

Please note that the two-part Epoxy glue layer 260 in the screen protection device 100 should not be replaced by a UV layer made by general UV glue. This is because that the circular fringes easily present when attaching the UV layer made by the UV glue onto the tempered glass sheet 210, and the circular fringes would cause adverse effect to the image quality of the image displayed on the display screen 202, which is difficult to satisfy the user's demand. In addition, the two-part Epoxy glue layer 260 has stickiness but the UV layer lacks of stickiness. Accordingly, when using the UV layer to replace the two-part Epoxy glue layer 260, adhesive glue should be coated onto the UV layer so that the UV layer can be indirectly attached onto the display screen. Obviously, such structure increases the thickness and weight of the entire screen protection device 100, which is difficult to satisfy the user's demand.

In practice, the two-part Epoxy glue layer 260 may be dimensioned to have a size substantially the same as the size of the display screen 202. For example, in the embodiment where the display screen 202 has a diagonal of 4 inches, the two-part Epoxy glue layer 260 may be dimensioned to have a diagonal equal to or slightly greater than 4 inches. In the embodiment where the display screen 202 has a diagonal of 5 inches, the two-part Epoxy glue layer 260 may be dimensioned to have a diagonal equal to or slightly greater than 5 inches. In the embodiment where the display screen 202 has a diagonal of 7 inches, the two-part Epoxy glue layer 260 may be dimensioned to have a diagonal equal to or slightly greater than 7 inches. In the embodiment where the display screen 202 has a diagonal of 11 inches, the two-part Epoxy glue layer 260 may be dimensioned to have a diagonal equal to or slightly greater than 11 inches. In the embodiment where the display screen 202 has a diagonal of 15 inches, the two-part Epoxy glue layer 260 may be dimensioned to have a diagonal equal to or slightly greater than 15 inches. The same design approach applies to other embodiments.

As can be appreciated from the foregoing descriptions, the proposed screen protection device 100 is applicable to the electronic apparatus 200 of any size, and can be even applied to a variety of tablet computers or televisions equipped with a larger screen.

In order to effectively reduce the sunken degree of the transparent area 101 of the screen protection device 100, the two-part Epoxy glue layer 260 may be designed to have a thickness which is at least 60% of a total thickness of the mask layer 220 and the adhesive layer 230. For example, the two-part Epoxy glue layer 260 may be designed to have a thickness of 65%, 70%, 75%, 80%, 85%, 90%, 95%, or 98% of the total thickness of the mask layer 220 and the adhesive layer 230. Of course, the two-part Epoxy glue layer 260 may be designed to have a thickness substantially the same as the total thickness as the mask layer 220 and the adhesive layer 230.

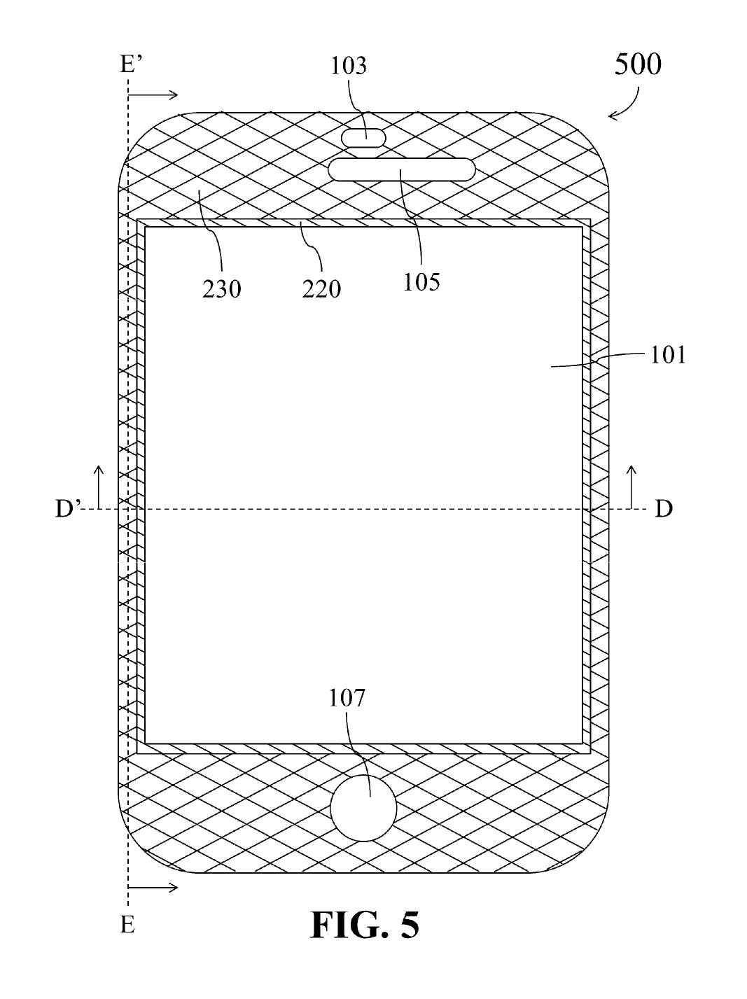

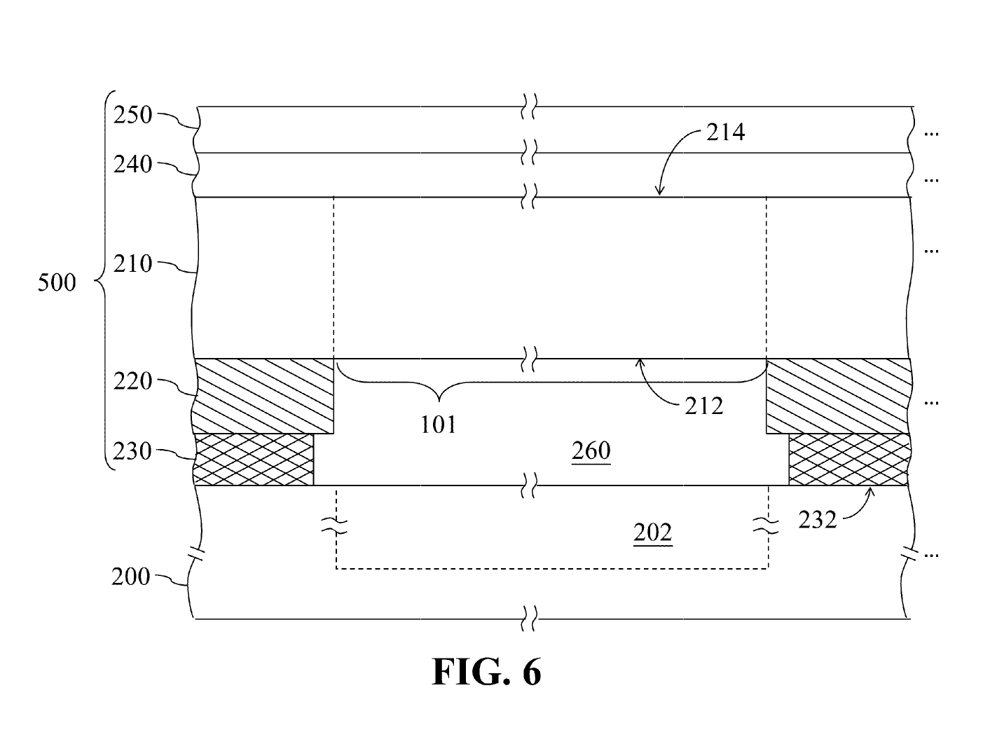

Please refer to FIG. 5 and FIG. 6. FIG. 5 is a schematic back view diagram of the screen protection device 500 in accordance with another example embodiment. FIG. 6 is a schematic cross-sectional diagram of the screen protection device 500 along the direction D-D′ of FIG. 5. The screen protection device 500 is similar to the previous screen protection device 100, and the difference between the two embodiments is the area of the adhesive layer 230 of the screen protection device 500 is smaller to the area of the mask layer 220. Therefore, as shown in FIG. 5, it can be seen from the back view of the screen protection device 500 that some regions of the mask layer 220 are not completely masked by the adhesive layer 230. Such arrangement effectively avoids the adhesive layer 230 from exposing to the scope of the transparent area 101 due to the misalignment in the manufacturing process. From another perspective, such arrangement provides a higher position error tolerance when coating the adhesive layer 230 onto the mask layer 220, thereby increasing the manufacturing speed and yield rate of the screen protection device 500.

In this embodiment, the schematic cross-sectional diagram of the screen protection device 500 along the direction E-E′ is the same as the previous schematic cross-sectional diagram of the screen protection device 100 along the direction C-C′. Accordingly, the descriptions regarding the implementations and advantages of corresponding elements in the screen protection device 100 are also applicable to this embodiment. For simplicity, the descriptions will not be repeated here.

Additionally, in some embodiments, the previous harden layer 240 and/or the antibacterial layer 250 may be omitted to further simplify the structure of the screen protection device.

In addition, in some embodiments where the screen protection devices 100 and 500 are applied to a television or computer screen, the previous openings 103, 105, and 107 may be omitted.

As can be seen from the foregoing descriptions, when the screen protection device 100 or 500 is attached onto the display screen 202 of the electronic apparatus 200, the two-part Epoxy glue layer 260 positioned between the tempered glass sheet 210 and the display screen 202 supports the weight of the screen protection device 100 or 500, thereby avoiding the phenomenon of Newton's rings caused by the deformation of the screen protection device 100 or 500.

Furthermore, the structure of the proposed screen protection devices 100 and 500 are very simple and compact, and can effectively increase the manufacturing yield rate of the screen protection devices 100 and 500.

Certain terms are used throughout the description and the claims to refer to particular components. One skilled in the art appreciates that a component may be referred to as different names. This disclosure does not intend to distinguish between components that differ in name but not in function. In the description and in the claims, the term “comprise” is used in an open-ended fashion, and thus should be interpreted to mean “include, but not limited to.”

The term “and/or” may comprise any and all combinations of one or more of the associated listed items. In addition, the singular forms “a,” “an,” and “the” herein are intended to comprise the plural forms as well, unless the context clearly indicates otherwise.

Throughout the description and claims, the term “element” contains the concept of component, layer, or region.

In the drawings, the size and relative sizes of some elements may be exaggerated or simplified for clarity. Accordingly, unless the context clearly specifies, the shape, size, relative size, and relative position of each element in the drawings are illustrated merely for clarity, and not intended to be used to restrict the claim scope.

For the purpose of explanatory convenience in the specification, spatially relative terms, such as “on,” “above,” “below,” “beneath,” “higher,” “lower,” “upward,” “downward,” and the like, may be used herein to describe the function of a particular element or to describe the relationship of one element to another element(s) as illustrated in the drawings. It will be understood that the spatially relative terms are intended to encompass different orientations of the element in use, in operations, or in assembly in addition to the orientation depicted in the drawings. For example, if the element in the drawings is turned over, elements described as “on” or “above” other elements would then be oriented “under” or “beneath” the other elements. Thus, the exemplary term “beneath” can encompass both an orientation of above and beneath.

Throughout the description and claims, it will be understood that when a component is referred to as being “positioned on,” “positioned above,” “connected to,” “engaged with,” or “coupled with” another component, it can be directly on, directly connected to, or directly engaged with the other component, or intervening component may be present. In contrast, when a component is referred to as being “directly on,” “directly connected to,” or “directly engaged with” another component, there are no intervening components present.

Other embodiments of the invention will be apparent to those skilled in the art from consideration of the specification and practice of the invention disclosed herein. It is intended that the specification and examples be considered as exemplary only, with a true scope and spirit of the invention indicated by the following claims.

What is claimed is:

1. A screen protection device for protecting a display screen of an electronic apparatus, comprising:
a tempered glass sheet having a first surface and a second surface;
a mask layer positioned on the first surface of the tempered glass sheet and defining a transparent area for the screen protection device, wherein the transparent area has a shape corresponding to the display screen of the electronic device;
an adhesive layer positioned on at least a portion of the mask layer, surrounding the transparent area, and utilized for detachably attaching to a target region of a surface of the electronic apparatus; and
a two-part Epoxy glue layer positioned on the first surface of the tempered glass sheet and covering the transparent area, wherein when the adhesive layer is attached onto the target region of the electronic apparatus, the two-part Epoxy glue layer is positioned between the tempered glass sheet and the display screen, directly contacts with the display screen, and detachably attaches onto the display screen;
wherein a thickness of the two-part Epoxy glue layer is at least 60% of a total thickness of the mask layer and the adhesive layer.

2. The screen protection device of claim 1, wherein a total surface area of the adhesive layer is less than a total surface area of the mask layer.

3. The screen protection device of claim 1, wherein the two-part Epoxy glue layer has a diagonal equal to or greater than 4 inches.

4. The screen protection device of claim 1, further comprising:
at least one opening positioned outside the transparent area of the screen protection device and penetrating the tempered glass sheet, the mask layer, and the adhesive layer.

5. The screen protection device of claim 4, further comprising:
a harden layer positioned on the second surface of the tempered glass sheet to protect the second surface of the tempered glass sheet;
wherein the tempered glass sheet has a thickness between 0.35 to 0.7 millimeters.

6. The screen protection device of claim 5, further comprising:
an antibacterial layer positioned on the harden layer to reduce or avoid bacteria.

7. The screen protection device of claim 3, further comprising:
a harden layer positioned on the second surface of the tempered glass sheet to protect the second surface of the tempered glass sheet;
wherein the tempered glass sheet has a thickness between 0.35 to 0.7 millimeters.

8. The screen protection device of claim 7, further comprising:
an antibacterial layer positioned on the harden layer to reduce or avoid bacteria.

9. The screen protection device of claim 2, further comprising:
a harden layer positioned on the second surface of the tempered glass sheet to protect the second surface of the tempered glass sheet;
wherein the tempered glass sheet has a thickness between 0.35 to 0.7 millimeters.

10. The screen protection device of claim 9, further comprising:
an antibacterial layer positioned on the harden layer to reduce or avoid bacteria.

11. The screen protection device of claim 1, further comprising:
a harden layer positioned on the second surface of the tempered glass sheet to protect the second surface of the tempered glass sheet;
wherein the tempered glass sheet has a thickness between 0.35 to 0.7 millimeters.

12. The screen protection device of claim 11, further comprising:
an antibacterial layer positioned on the harden layer to reduce or avoid bacteria.

13. A screen protection device for protecting a display screen of an electronic apparatus, comprising:
a tempered glass sheet having a first surface and a second surface, wherein the tempered glass sheet has a thickness between 0.35 to 0.7 millimeters;
a mask layer positioned on the first surface of the tempered glass sheet and defining a transparent area for the screen protection device, wherein the transparent area has a shape corresponding to the display screen of the electronic device;
an adhesive layer positioned on at least a portion of the mask layer, surrounding the transparent area, and utilized for detachably attaching to a target region of a surface of the electronic apparatus, wherein the adhesive layer has a thickness less than a thickness of the mask layer, and a total surface area of the adhesive layer is less than a total surface area of the mask layer;
a harden layer positioned on the second surface of the tempered glass sheet to protect the second surface of the tempered glass sheet;
a two-part Epoxy glue layer positioned on the first surface of the tempered glass sheet and covering the transparent area, wherein the two-part Epoxy glue layer has a diagonal greater than 5 inches, and a thickness of the two-part Epoxy glue layer is at least 80% of a total thickness of the mask layer and the adhesive layer; and
at least one opening positioned outside the transparent area of the screen protection device and penetrating the tempered glass sheet, the mask layer, and the adhesive layer;
wherein when the adhesive layer is attached onto the target region of the electronic apparatus, the two-part Epoxy glue layer is positioned between the tempered glass sheet and the display screen, directly contacts with the display screen, and detachably attaches onto the display screen.
